(19) United States
(12) Patent Application Publication
(10) Pub. No.: US 2022/0058480 A1
(43) Pub. Date: Feb. 24, 2022

(54) Threshold Variation Compensation of Neurons in Spiking Neural Networks

(71) Applicant: Seoul National University R&DB Foundation, Seoul (KR)

(72) Inventors: Byung-Gook PARK, Seoul (KR); Kyungchul PARK, Seoul (KR)

(21) Appl. No.: 17/110,061

(22) Filed: Dec. 2, 2020

(30) Foreign Application Priority Data
Aug. 20, 2020 (KR) 10-2020-0104568

(51) Int. Cl. G06N 3/08; G06N 3/04; G06N 3/063

(52) U.S. Cl. CPC G06N 3/08; G06N 3/063; G06N 3/049

(57) ABSTRACT

The present inventive concept provides a method for compensating a neuron threshold variation for firing in a neural network apparatus. The method compensates a threshold variation adjusting an effective threshold to a target threshold in each neuron. The effective threshold is for a next firing after the firing of each neuron.

### CROSS-REFERENCE TO RELATED APPLICATIONS

A claim for priority under 35 U.S.C. § 119 is made to Korean Patent Application No. 10-2020-0104568 filed on Aug. 20, 2020, in the Korean Intellectual Property Office, the entire contents of which are hereby incorporated by reference.

### BACKGROUND

Embodiments of the present inventive concept described herein relates to a neural network and, more specifically, to a spiking neural network.

With the 4th industrial revolution, an artificial intelligence and an artificial neural network related to the artificial intelligence have been paid high attention. In the conventional artificial neural network, all nodes are completely connected, and input and output continuous values, thereby the conventional network does not mimic a biological mechanism of a real neuron. In addition, because the conventional artificial neural network is implemented in a traditional Von Neumann architecture, the conventional network has a disadvantage that it is driven by a serial processing and it consumes large amounts of energy. In order to overcome this problem, studies on spiking neural networks (SNNs) that mimic the signal transmission method of a brain have been actively conducted. The SNNs are composed of synapse devices defining a weight of a neural network in hardware, and neuron circuits of integration-firing. The neuron circuit accumulates signals in a membrane capacitor and fires an output spike when an accumulated potential (membrane potential) exceeds a predetermined threshold voltage. After the firing, the neuron circuit discharges the accumulated membrane potential by the threshold voltage, and then returns to a state for accumulation.

The SNNs describe biological neuron in more detail than the conventional artificial neural network, and thus a neuron in the SNNs outputs a spike like an electrical signal of a biological neuron. Other feature of the SNN neuron is that outputs vary over the time in the neuron itself. This means that processing the data depending on time is possible without increasing the complexity of the neural network itself.

The SNNs have proven to be more useful than the conventional artificial neural networks in several studies, but an optimal algorithm that trains the SNNs effectively has not yet been developed. In addition, in the SNNs, a large amount of calculation is required because a variation of the output value over time should be continuously calculated in every neuron. Therefore, in the SNN art field, various studies have been conducted in order to solve the problems associated with training, calculation, and the like.

### SUMMARY

However, the present inventors recognize problems that have not been discussed in any way or recognized as an issue, and suggest a solution thereto.

The present inventors notice distribution in a device characteristic may exist in the case that a threshold voltage of each neuron for a firing with respect to an integration and firing and the SNNs are implemented in hardware. For accurate inference, each neuron should maintain the same threshold voltage for consistent input and output characteristics. Thus, if the threshold voltage of each neuron is different from each other, the inference of the SNNs may be inaccurate. Accordingly, the present inventors provide methodologies capable of accurate inference by compensating the threshold voltages although the threshold voltages of each neuron in the SNNs is different.

One aspect of the present inventive concept provides a method for compensating a difference and/or a variation of neuron threshold for a firing in a neural network, the method comprising: adjusting an effective threshold for a next firing after a firing of each neuron to be the same as a target threshold in each neuron.

Another aspect of the present inventive concept provides a method for discharging a membrane potential after a firing of neuron in a spiking neural network, the method comprising discharging the same amount of a membrane potential for each neuron after the firing.

Another aspect of the present inventive concept provides a method for resetting a neuron for a next firing after a firing of a neuron in a neural network, the resetting comprising reducing the amount of accumulated input signals by the same amount for each neuron.

Another aspect of the present inventive concept provides a spiking neural network comprising a plurality of neural elements, wherein the plurality of neural elements time-integrate and accumulate an input signal and fire an output spike when the accumulated input signal exceeds a threshold, and wherein after firing the spike, the amount of accumulated input signals is reduced by the same amount of a target threshold for firing next spike.

According to the present inventive concept, an inference accuracy can be improved by simply and effectively compensating a threshold variation and/or change.

According to the present inventive concept, the inference accuracy can be further improved by preserving an excess membrane potential signal.

According to the present inventive concept, it is possible to shift an effective threshold of a spiking neuron by changing a target threshold, thereby a system which can make a negative membrane potential effect can be implemented without using a negative membrane potential.

According to the present inventive concept, even if the system allows the negative membrane potential, the inference accuracy can be improved.

According to the present inventive concept, when an SNN is implemented in hardware, a manufacturing process is simplified.

The above and other objects and features will become apparent from the following description with reference to the following figures, wherein like reference numerals refer to like parts throughout the various figures unless otherwise specified, and wherein

### BRIEF DESCRIPTION OF THE FIGURES

FIG. 1 shows a principle of a threshold compensation method according to the present inventive concept.

FIG. 2 shows a method for compensating a threshold variation among neurons, which may occur when an SNN is implemented in hardware, according to the present inventive concept.

FIG. 3 shows one neuron element according to one embodiment of the present inventive concept.

FIG. 4 is a schematic diagram of an SNN comprising N neuron elements of FIG. 3.

FIGS. 5 to 7 show various exemplary embodiments of an accumulation unit and a threshold adjusting unit for implementing a threshold compensation method of the present inventive concept.

FIG. 8 shows an overall circuit configuration of the neuron element employing threshold variation and/or change compensation according to the present inventive concept, and these circuits are merely examples and can be implemented in a variety of circuit configurations.

FIG. 9 is a graph for explaining an operation of the neuron of FIG. 8.

FIG. 10 shows a neuron composed by omitting two inverters (two inverters between nodes 4 and 5) of three back-end inverters, replacing the discharge PMOS transistor with an NMOS transistor, and connecting the gate to the output terminal (node 2) of the neuron in the neuron of FIG. 8.

FIG. 11 shows a neuron composed by not using FBRFET for low power operation used in the neuron of FIGS. 8 and 10, but using an inverter between node 3 and node 4.

FIGS. 12 and 13 are simulation results that a CNN learns a weight through a back propagation, which is a conventional learning method of a deep learning and the same CNN using the learned weights is driven with SNN, so that FIGS. 12 and 13 are simulation results of the accuracy of inference by driving the SNN with the variation of the threshold among neurons with respect to each membrane potential method.

FIG. 14 shows a result of testing the inference accuracy by simulating a situation of changing a threshold according to an increasing speed of an input depending on the characteristics of a neuron using the neuron of FIG. 8.

### DETAILED DESCRIPTION

The present inventive concept and methods of accomplishing the same may be understood more readily by reference to the following detailed description of embodiments and the accompanying drawings. However, the present inventive concept may be embodied in many different forms, and should not be construed as being limited to the embodiments set forth herein. Rather, these embodiments are provided so that this inventive concept will be thorough and complete and will fully convey the concept of the invention to those skilled in the art, and the present inventive concept will only be defined by the appended claims.

Unless defined otherwise, all terms used herein, including technical or scientific terms, have the same meaning as commonly understood by one of ordinary skill in the art to which this invention belongs. Terms such as those defined in commonly used dictionaries should be interpreted as having a meaning that is consistent with their meaning in the context of the relevant art and are not to be interpreted in an idealized or overly formal sense unless expressly so defined herein. The term used herein describes the embodiment of the present disclosure and not be limited to the present disclosure.

It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “or” in the claims is used to mean “and/or” unless explicitly indicated to refer to alternatives as mutually exclusive. Thus, unless otherwise stated, the term “or” in a group of alternatives means “any one or combination of” the members of the group. Further, unless explicitly indicated to refer to alternatives as mutually exclusive, the phrase “A, B, and/or C” means embodiments having element A alone, element B alone, element C alone, or any combination of A, B, and C taken together.

Similarly, for the avoidance of doubt and unless otherwise explicitly indicated to refer to alternatives as mutually exclusive, the phrase “at least one of” when combined with a list of items, means a single item from the list or any combination of items in the list. For example, and unless otherwise defined, the phrase “at least one of A, B and C,” means “at least one from the group A, B, C, or any combination of A, B and C.” Thus, unless otherwise defined, the phrase requires one or more, and not necessarily not all, of the listed items.

It will be understood that when an element or unit or the like is referred to as being “connected to”, “coupled to”, or “adjacent to” another element or unit or the like, it can be directly connected, coupled, or adjacent to the other element or unit or the like, or intervening elements or unit or the like may be present. In contrast, when an element is referred to as being “directly connected to”, “directly coupled to”, or “immediately adjacent to” another element or unit or the like, there are no intervening elements or unit or the like present.

Term “unit” may be used to indicate a unit of processing at least one function or operation. For example, such term “unit” may mean software, or a hardware element such as ASIC or FPGA. However, such terms are not limited to software or hardware. The “unit” may be configured to be included within an addressable storage medium or to operate one or more processors. Thus, “unit” may include constituent elements such as software elements, Object-Oriented software elements, class elements, and task elements, processes, functions, attributes, procedures, sub-routines, segments of program code, drivers, firmware, micro code circuit, data, database, data structures, tables, arrays, and variables. Elements and functions provided within the “unit” may be jointed to reduce the number of elements and the “unit”, or may be additionally divided into elements and “unit”.

Embodiments of the present inventive concept relate to a neural network and, more specifically, to a spiking neural network.

Although a conventional Artificial Neural Network (ANN) has started from the simulation of the real biological nervous system (the concept of memory, learning, and interference), the neural network currently being used adopting only a network structure similar to a biological nervous system, but it is different from a real biological nervous system in various aspects, such as signal transmission method and information presentation, transfer functions (activation functions) of neurons, learning methods, and the like.

However, Spiking Neural Networks (SNNs) are neural networks that mimic the signal transmission method of the biological nervous system, and consist of synapse devices defining the weight of the neural network in hardware, and neurons that function as time integration (accumulation) of a signal and firing mimicking the signal transmission method of the brain.

Though the SNNs behave almost similarly to the real biological nervous system, a learning method that shows performance beyond the conventional neural network has not been developed yet, so that a real industry less uses the SNNs. However, if the synaptic weight obtained by using the conventional neural network is utilized and the inference is performed in the SNNs, a high inference accuracy can be obtained and a very low power computing system can be implemented at the same time, so that a research on the SNNs is being actively conducted. If the synaptic weight learned through the conventional neural network is applied into the SNNs for inference, it is possible to perform almost the same level of the conventional neural network in the SNN.

However, unlike previous research and development in the SNNs field, the present inventors have paid attention to a problem that can occur in implementing the SNNs in hardware, and to derive a solution to the problem associated with the hardware implementation of the SNNs, based on the insight of a basic operation principle of the SNNs. That is, the present inventors recognize that a characteristic distribution occurs between neurons when the SNNs are implemented in hardware, and in particular, recognize that a distribution of a threshold for the firing of neurons occurs with respect to a basic operation of the SNN, and simply and effectively suggest a solution to the problem based on the basic operation principle of the SNNs.

Because a spiking neuron outputs a spike when a time-integrated membrane potential exceeds a threshold, the threshold is a key factor for determining a spike rate (the number of spikes per unit time). Because the size of one spike is constant, the spike generation rate becomes an output value of the spiking neuron. Thus, the variation of the threshold affects a critical influence on the output value of the spiking neuron. If a plurality of spiking neurons are used, a variation in a threshold inevitably occurs during the implementation of a device and a circuit. Even if the neurons can be manufactured with substantially the same threshold, the threshold could be changed due to a difference in an operating condition among neurons.

The present inventors recognize this problem and invent a simple and effective threshold compensation method based on a basic operation principle of the spiking neuron to solve the problem.

Intuitively, for example, compensating the difference in threshold among neurons is to discharge a membrane potential by different amount in accordance with the difference.

However, the present inventors have invented a new method for compensating a threshold which is out of intuition, based on the basic operation principle of the spiking neuron.

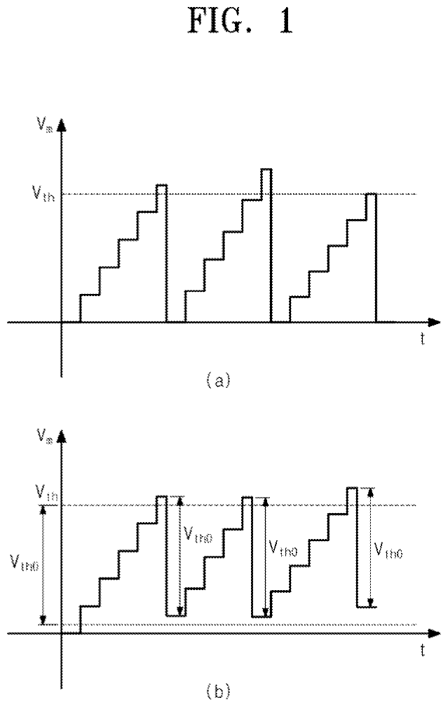

The principle of the threshold compensation method according to the present invention will be described with reference to FIG. 1. FIG. 1a is a graph illustrating the operation principle of the spiking neuron. Referring to FIG. 1a, a membrane potential (Vₘ) is discharged (reset) immediately after a spike occurs. After reset, the membrane potential increases as weighted inputs are integrated over time, and a next spike occurs at the moment the membrane potential reaches again the threshold (Vₜₕ).

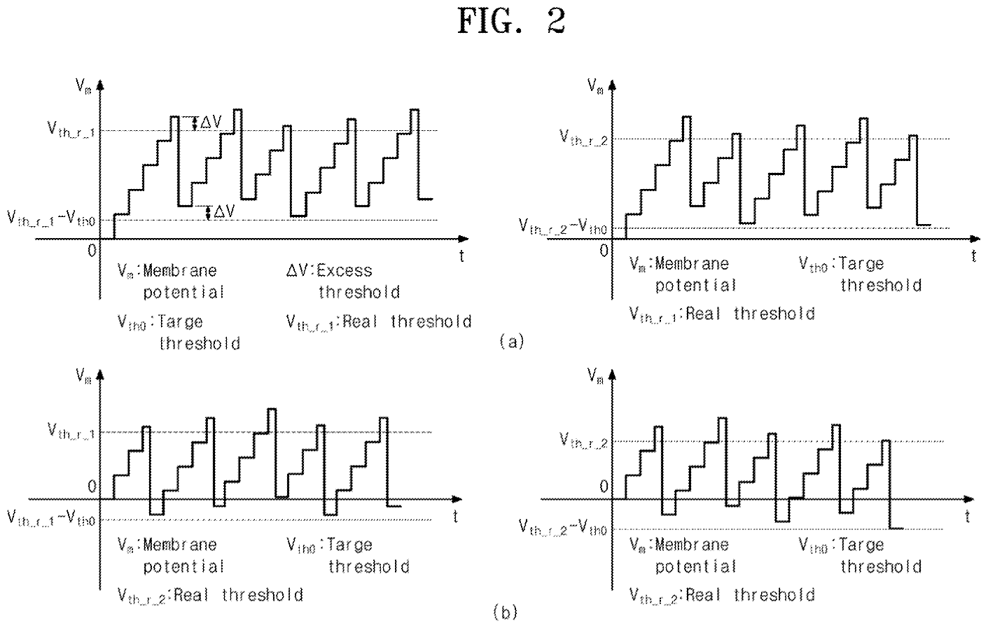

Here, the inventors have perceived, from the insight into the basic operation of the spiking neuron, that the amount of a membrane potential to be discharged after spike generation is an effective threshold for a next spike generation. This is, because the threshold is constantly maintained during charging and discharging of the membrane potential and thus the time integrated value of the weighted inputs should be equal to or greater than the amount of the discharged membrane potential. Accordingly, if the effective threshold is set to a target threshold (Vₜₕ₀) in all neurons, the effective threshold for all subsequent spikes can be maintained as the same as the target threshold (Vₜₕ₀) for all neurons, and thus the threshold difference and/or the variation among neurons can be compensated (described in detail with reference to FIG. 2).

Referring to FIG. 1b, the amount of the membrane potential which is discharged immediately after the spike generation is constant as the amount of the target threshold (Vₜₕ₀), and thus the effective threshold for all subsequent spikes is equal to the target threshold (Vₜₕ₀).

The present inventive concept suggests a resetting or discharging membrane potential to that the amount of the membrane potential discharged immediately after the spike generation becomes the same in all neurons. According to the present inventive concept, because the amount of the discharged membrane potential immediately after the spike generation becomes the same, the effective threshold is the target threshold in the generation of all spikes except for the first spike. Thus, an error (e.g., inference error) can occur by a threshold deviated from the target threshold only in the first spike, and errors by a threshold difference do not occur in the second and subsequent spikes. The first spike error can be reduced to a desired level by calculating the spike generation rate after a sufficient number of spikes, or calculating the spike generation rate except for the initial spike.

On the other hand, in the method of the present inventive concept, the membrane potential immediately after the discharging membrane potential caused by spike generation may be expressed by the following equation:

V^{ts+}_{m_k}=(V^{ts-}_{m_k})−Vₜₕ₀+ΔV (Equation 1)

In Equation 1, V^{ts+}_{m_k} is a membrane potential value (V) immediately after the discharging, V^{ts-}_{m_k} is a membrane potential value (V), which is a time-integration of weighted input right before a firing, and ΔV is an accumulated membrane potential exceeding a real threshold (V_{th_r_k}), and K=1, 2, 3, . . . N (N is the number of neurons of the neural network).

The method for discharging the membrane potential of the present inventive concept discharges the membrane potential by the same amount (the amount of the target threshold (Vₜₕ₀)) in all neurons immediately after the spike generation. Thus, the amount of the membrane potential to be charged for the next spike generation are the same as the target threshold (Vₜₕ₀) in all neurons, thereby the threshold difference and/or variation among neurons are compensated.

In the present inventive concept, because the membrane potential is discharged by the same amount (e.g., by the amount of the target threshold (Vₜₕ₀)) in each neuron immediately after the spike generation, the effective threshold for the second and subsequent spikes is the same as the target threshold value (Vₜₕ₀) in all neurons even though the real threshold value (Vₜh r k) of each neuron is different. On the other hand, the excess membrane potential (ΔV) is also preserved, thereby it contributes to the improvement of the SNN inference accuracy. In addition, according to the present inventive concept, if the target threshold (Vₜₕ₀) is appropriately adjusted, the effective threshold of the spiking neuron can be shifted. For example, a system which can have a negative membrane potential effect can be implemented without using a negative membrane potential. In addition, unlike above, for example, by shifting the effective threshold, for example, reducing the amount of discharge (e.g., by setting the target threshold value (Vₜₕ₀) to be low), it is possible to avoid a situation that a negative membrane potential should be used.

The unique and special method of the present inventive concept described above is based on the basic operating principle of the spiking neuron of the SNNs and the threshold difference and/or variation are simply and effectively compensated. In addition, because all neurons are discharged by the same amount, a manufacturing process is simplified when the SNNs are implemented in hardware.

The threshold difference compensation method of the present inventive concept can be better understood with reference to the graph of FIG. 2. FIG. 2 is a graph showing a method for compensating a threshold difference among neurons which may occur when the SNN is implemented in hardware, according to the present inventive concept. When the SNN is implemented in hardware, the real threshold (V_{th_r_k}) of neurons may be higher or lower than the desired threshold (the designed threshold V_{th_design}). In FIG. 2, two neurons having different thresholds V_{th_r_1} and V_{th_r_2} is considered for convenience of explanation and better understanding of the present inventive concept. FIG. 2a shows a membrane potential (Vₘ) of two neurons (neuron 1 and neuron 2) which have a real threshold V_{th_r_k} higher than the designed threshold (V_{th_design}), and FIG. 2b shows a membrane potential (Vₘ) of two neurons (neuron 1 and neuron 2) which have a real threshold V_{th_r_k} lower than the designed threshold (V_{th_design}).

Referring to FIGS. 2a and 2b, the real thresholds V_{th_r_1} and V_{th_r_2} of neuron 1 and neuron 2 for the first spike generation are different from each other, but immediately after the first spike generation, both the neuron 1 and neuron 2 are discharged by the same amount of the target threshold(Vₜₕ₀) (e.g., the designed threshold(V_{th_design}), thereby the effective threshold for subsequent spikes is set to the same value, the target threshold(Vₜₕ₀), for both neuron 1 and neuron 2, (if not considering the excess membrane potential(ΔV)) the amount of charging potential for the next spike generation is the same, the target threshold(Vₜₕ₀), for both neuron 1 and neuron 2.

Accordingly, in the present inventive concept, the membrane potential of the neuron after the spike generation is discharged by the same amount, the target threshold (Vₜₕ₀), for all neurons, thus the difference and/or variation among neurons are compensated. In addition, the excess membrane potential signal is also preserved, and it contributes to an improvement of the SNNs inference accuracy.

On the other hand, if the real threshold is lower than the target threshold (FIG. 2b), a negative membrane potential should be allowed, and allowing the negative membrane potential can contribute to the improvement of the SNN inference accuracy.

The negative membrane potential can be implemented by using a negative signal (e.g., a negative voltage), but such an implementation may increase the complexity of neuron circuit (e.g., use of a positive voltage source and a negative voltage source). In FIG. 2b, it is noticeable that the negative membrane potential will disappear if the target threshold is sufficiently lower than the real threshold of all neurons. In case it is difficult to reduce the target threshold the designed threshold (V_{th_design}) can be set sufficiently higher than the target threshold(Vₜₕ) considering the variation of the threshold implemented in hardware, making the real threshold of all neurons higher than the target threshold so that it can be avoidable that the membrane potential after the discharging becomes negative.

The method for compensating the threshold of the present inventive concept described above can apply to any types of SNNs, and hereinafter, devices and circuits or the like are described as examples for explanation and understanding of the present inventive concept and not limited thereto.

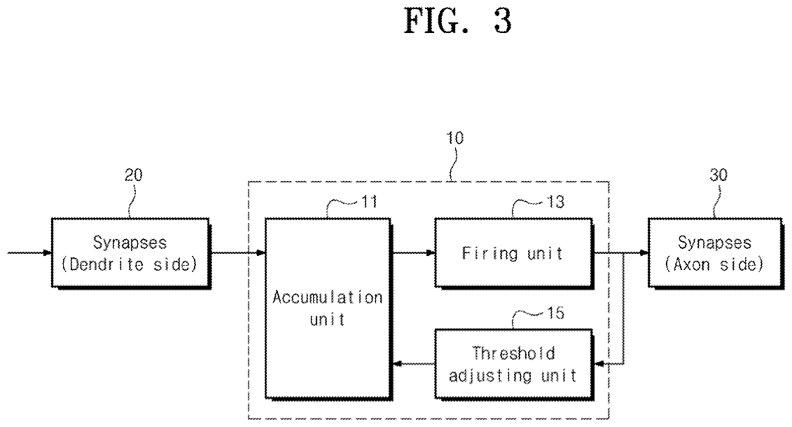

FIG. 3 shows a neuron according to an example of the present inventive concept. Referring to FIG. 3, the neuron 10 includes an accumulation unit 11, a firing unit 13, and a threshold adjusting unit 15.

The accumulation unit 11 of the neuron 10 time-integrates and accumulates an input signal (e.g., current) from synapses (dendrite side) 20.

The firing unit 13 connects to the accumulation unit 11, and when a charging voltage of the accumulation unit 11 exceeds the threshold by accumulating electric charges, the neuron fires to generate a spike.

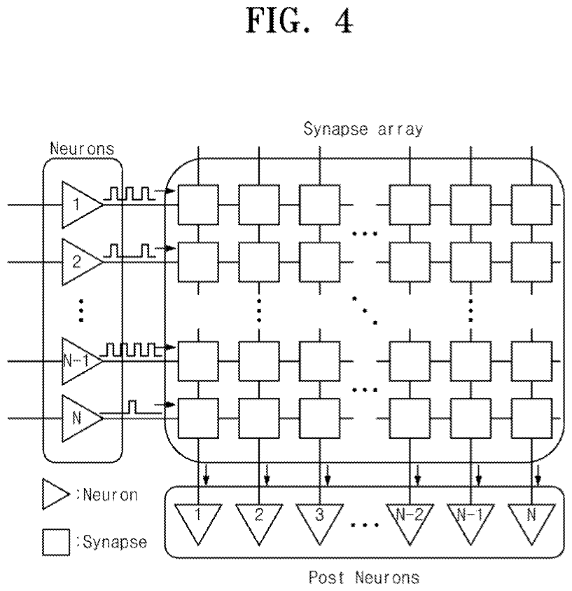

The threshold adjusting unit 15 is connected between the firing unit 13 and the accumulation unit 11, and if the spike is generated at an output terminal, the threshold adjusting unit 15 drives to discharge the accumulation unit 11 by a predetermined amount (target threshold (Vₜₕ₀)). Accordingly, the voltage level of the accumulation unit 11 decrease by the amount of the target threshold (Vₜₕ₀). The amount that the threshold adjusting unit 15 discharges membrane potential accumulated in the accumulation unit 11 is the same in all neurons composing the SNN, and therefore, the effective threshold for generating the subsequent spikes in all neurons becomes the same as the target threshold value (Vₜₕ₀). FIG. 4 is a schematic diagram of the SNN comprising N neurons of FIG. 3.

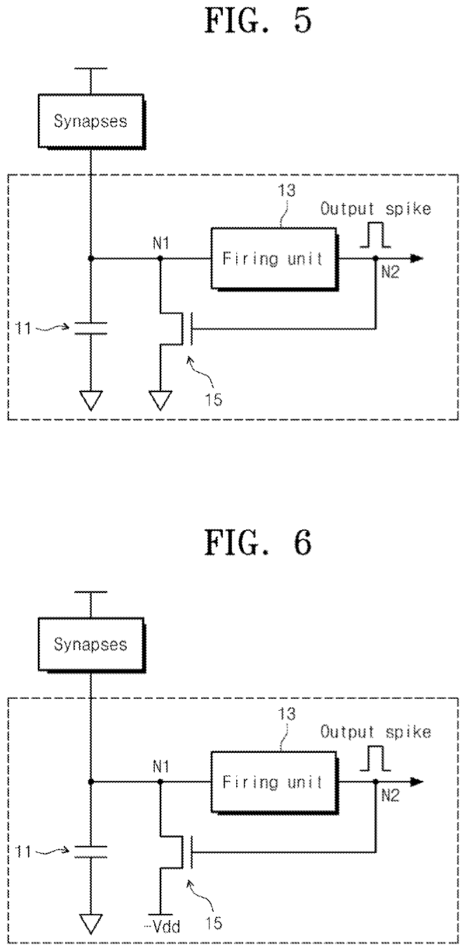

Hereinafter, various embodiments of the accumulation unit and the threshold adjusting unit for implementing the method for compensating the threshold of the present inventive concept will be described with reference to FIG. 5 to FIG. 7. First, referring to FIG. 5, the accumulation unit is implemented by the membrane capacitor 11 and the threshold adjusting unit is implemented by a discharge NMOS transistor 15. A gate of the discharge NMOS transistor 15 is connected to an output terminal (node N2) of the firing unit 13 and a drain is connected to a node N1 between the membrane capacitor 11 and the firing unit 13. Accordingly, when the membrane potential of the membrane capacitor 11 reaches the threshold (V_{th_r_k}), the firing unit (neuron) 13 generates a spike at the output node (N2), and accordingly, the discharge NMOS transistor 15 is turned on to discharge the membrane capacitor 11 by the predetermined amount. The amount that the discharge NMOS transistor 15 discharges the membrane capacitor 11 can be adjusted to desired amount (the amount corresponding to the target threshold (Vₜₕ₀)) by controlling a threshold voltage of the discharge NMOS transistor 15, the current driving capability (gate width, gate length, etc.), and the shape (width, etc.) of the spike generated by the firing unit 13. By configuring each firing unit and each discharge NMOS transistor to be the same in all neurons, the accumulation unit of all neurons will discharge the same amount (e.g., the amount, target threshold (Vₜₕ₀)) when the spike is generated.

The spike generated by the neuron 13 is shown in the form of a square wave, but various waveforms such as a triangle wave, a sawtooth wave, or the like are possible.

In exemplary embodiment shown in FIG. 6, compared with FIG. 5, the discharge NMOS transistor 15 discharges the accumulation unit 11 using a negative voltage (−V_{d}), which is for the negative membrane potential necessary to compensate the threshold difference and/or variation as shown in FIG. 3(b).

FIG. 7 is an example that the threshold adjusting unit 15 comprises a plurality of transistors 15a, 15b, 15c. In this example, with the discharge NMOS transistor 15a, a pass PMOS transistor 15b and a discharge PMOS transistor 15c separating the firing unit (neuron) 13 and the accumulation unit 11, the discharge NMOS transistor 15a can discharge the membrane capacitor 11.

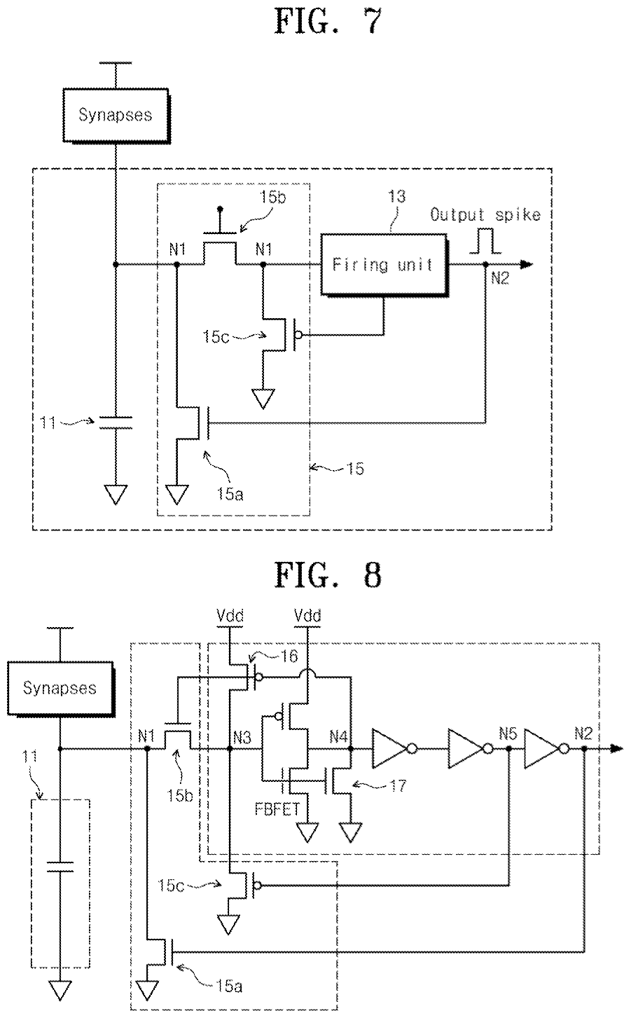

FIG. 8 is an overall circuit configuration of a neuron capable of compensating threshold difference, according to an exemplary embodiment of the present inventive concept, and these circuits are merely examples and can be implemented in a variety of circuit configurations.

Referring to FIG. 8, an operation of exemplary neuron is described. First, the initial state of each node is as follows: Node 1(N1):‘low’, Node 3(N3):‘low’, Node 4(N4):‘high’, Node 5(N5): ‘high’, Node 2(N2):‘low’. In the initial state, the membrane potential of the membrane capacitor 11 increases as input currents from the synapses 20 are accumulated in the membrane capacitor 11. When the membrane potential of the membrane capacitor 11 increases to reach the real threshold (V_{th_r_k}), the feedback transistor (FBFET) operates to discharge the node 4 (N4), so that the node 4 becomes ‘low’ from ‘high’. The pass NMOS transistor 15b is turned off so that the nodes 1 and 3 are separated. However, a boosting PMOS transistor 16 operates to pull up the node 3 to V_{dd}. The NMOS transistor 17 parallel-connected with the FBFET is operated to completely discharge the node 4, so that the node 4 becomes ‘low’ from ‘high’. Accordingly, the serially connected back-end inverters are operated to raise the voltage of the neuron output terminal (node 2) to V_{dd} (generating spike) (Node 1: ‘high’, Node 3: ‘high’, Node 4: ‘low’, Node 5: ‘low’, Node 2: ‘high’). At this time, the discharge PMOS transistor 15c is operated by the node 5, the node 3 is firstly discharged to initialize the back-end inverters, and since the node 2 is high, the discharge NMOS transistor 15a discharges the membrane capacitor 11 by the amount of the target threshold value (Vₜₕ₀).

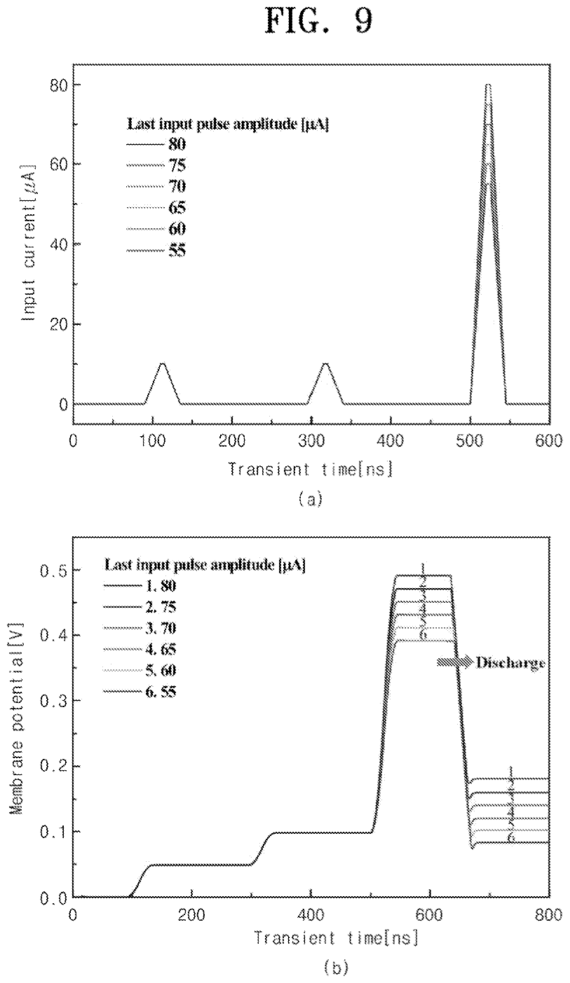

FIG. 9 is a graph for explaining the operation of the neuron of FIG. 8. Charging and discharging a membrane potential of the membrane capacitor 11 are shown in response to six input events, each input event comprises three sequential current pulses with the third current pulse being different one another.

As the current is inputted in each input event, the membrane potential of the membrane capacitor 11 is charged. When the membrane potential reaches threshold, the membrane capacitor 11 discharges the same and constant amount by the discharge NMOS transistor 15a immediately after the spike generation in each event. That is, the differences in the membrane potential among input events are maintained between before and after discharging.

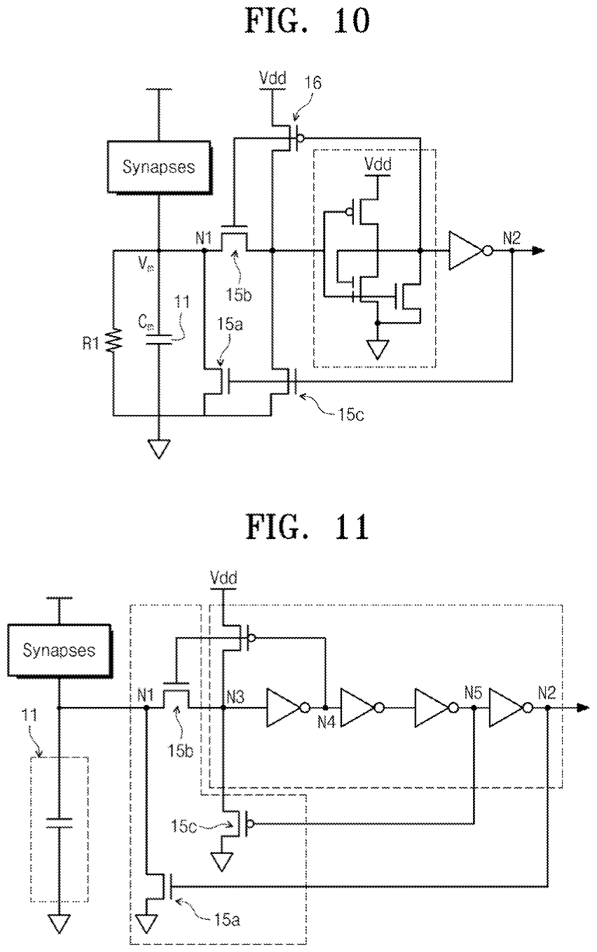

The neuron of FIG. 10 is configured by omitting two inverters (two inverters between nodes 4 and 5) of three back-end inverters of the neuron of FIG. 8, and by replacing the discharge PMOS transistor with an NMOS transistor, and by connecting the gate thereof to the output terminal (node 2) of the neuron.

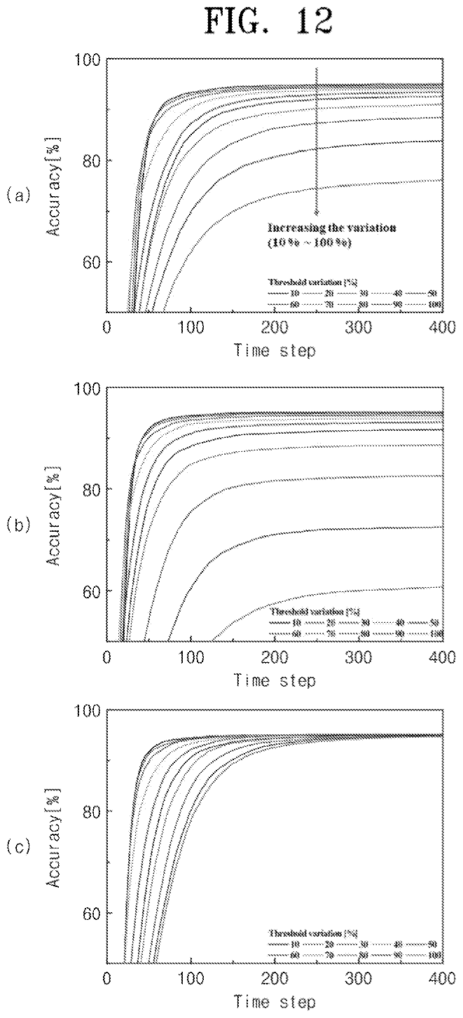

The neuron of FIG. 11 is configured by using an inverter between node 3 and node 4, without using the FBRFET for the low power operation used in the neurons of FIGS. 8 and 10.

The neurons of FIGS. 5 to 11 are merely an example of implementing the threshold compensation of the present inventive concept, and can be implemented using various circuits. For example, the neuron may be implemented by including a memristor such as a resistive memory (ReRAM), a phase-change memory (PRAM), a ferroelectric memory (FRAM), a magnetic memory (MRAM), and an SRAM, a floating gate device, a spin device, an NPN device, a CMOS-based device. For example, the accumulation unit 11 may be implemented based on the memristor, the floating gate device, and the NPN device, instead of the membrane capacitor, and an any device capable of time-integrating and accumulating an input signal may be used. Similarly, a voltage, an electromagnetic signal, a magnetic signal, and an optical signal may be used as an input signal, which can be time-integrated and accumulated in the accumulation unit 11 as well as a current.

Hereinafter, the effect of the present inventive concept is described.

Advantages of the present inventive concept over the conventional art.

In the conventional art, two methods have been used for resetting the membrane potential. One approach is “reset to zero”, discharging the membrane potential to zero immediately after the spike generation, the other approach is “reset by threshold”, discharging the membrane potential by a threshold of the corresponding neuron. These conventional membrane potential discharging methods are for a single neuron and do not consider the threshold difference and/or variation among neurons. Therefore, according to those conventional art, it is difficult to obtain an inference accuracy when there is a difference in threshold values among neurons. That is, in the conventional “ reset to zero ” method, the membrane potential is reset to ‘0’. Accordingly, under the threshold difference and/or variation among neurons, it is inevitable that the amount of the membrane potential charged to each neuron for next spike generation, is different among neurons. In the conventional “ reset by threshold ” method, the neuron is discharged by its threshold to be reset. Accordingly, under the threshold difference and/or variation among neurons, it is inevitable that the amount of the membrane potential charged to each neuron for the next spike generation, is different.

However, the present inventive concept discharges the membrane potential by the same amount, the target threshold, in all neurons, and thus, the present inventive concept has an advantage of obtaining a compensation effect on the real threshold difference and/or variation, as well as an effect of improving inference accuracy by preserving the excess membrane potential signal. In addition, even if a negative membrane potential is necessary, inference accuracy improvement effect can be obtained. Further, the method of the present inventive concept can shift the effective threshold of the spiking neuron by changing the target threshold, and thus, it is possible to implement a system capable of generating a negative membrane potential effect without using the negative membrane potential. The present inventive concept can be generally used for any spiking neurons, thus the present inventive concept can be applied to any systems using a spiking neuron, such as a sensor or the like, as well as a neural network.

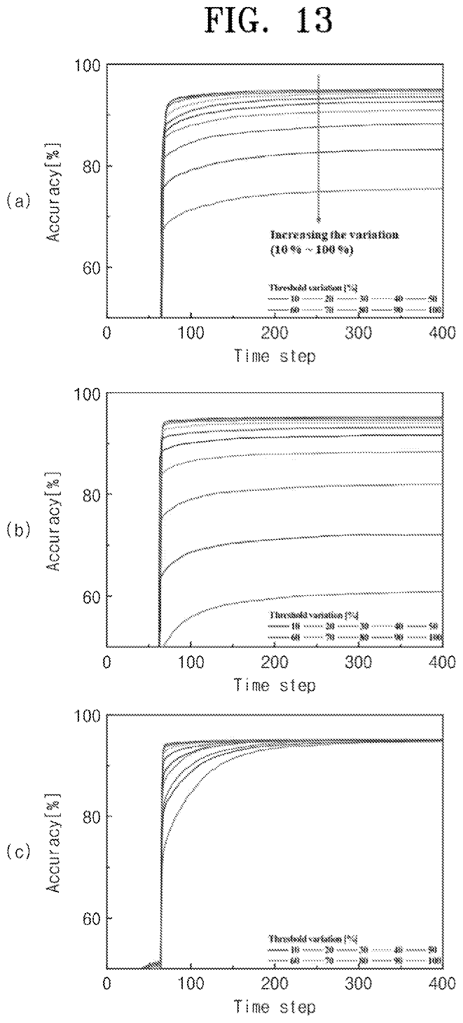

The effects and advantages of the present inventive concept will be described in more detail with reference to the drawings. FIGS. 12 and 13 show simulation results showing accuracy over timestep for three SNNs, adopting different membrane potential discharging methodologies: (a) conventional “reset-to-zero”; (b) conventional “reset by threshold”; and (c) the present inventive concept compensating variations/differences in threshold (“reset by target threshold”), respectively. In the simulation, firstly a convolutional neural network (CNN) was trained by using back propagation to obtain weights and then the SNNs adopting the different membrane potential discharging methodologies were tested on the same CNN architecture using the trained weights. Because one image is input to a spike according to a time step in the SNN, FIG. 12 and FIG. 13 show inference accuracy over time steps. The parameters used in training the CNN are as follow:

^{r}The dataset used for the CNN learning is the Street View House Number (SVHN), and its accuracy is 95.11%;

CNN structure: 40C3-40C3-40C3-100C3-100C3-100C3-100C3-500FCN-500FCN-10 (2×2 average pooling for the 3^{rd} and 6^{th} layer, no padding for all convolution layers),

First, referring to FIG. 12, it can be seen that the inference accuracy of (c) “reset by target threshold” for all neurons according to the present inventive concept is much higher than those of the conventional methods (a) “reset-to-zero” and (b) “reset by threshold”. In the conventional membrane potential discharging method (a) and (b), if the threshold variation exceeds 20%, the reduction of the inference accuracy appears, and if the threshold variation exceeds 50%, the inference accuracy is drastically reduced. However, in the present inventive concept (“rest by target threshold”)(c), it can be seen that though it takes a little longer time as the threshold variation increases, eventually the inference accuracy is completely restored (accuracy reduction at timestep 400 becomes less than 0.5%, as compared to no variation of the threshold, and becomes less than 0.01% as enough time goes by.)

On the other hand, as the threshold variation increases, the increasing rate in the inference accuracy is getting slow, which is an effect of the threshold error occurring in the first spike. However, this error caused by the first spike can be compensated as shown in FIG. 13 by calculating the threshold error occurrence rate except for the initial spike. Similarly, as shown in FIG. 13, it can be seen that the discharging method (c) of the present inventive concept is superior to the conventional methods (a) and (b).

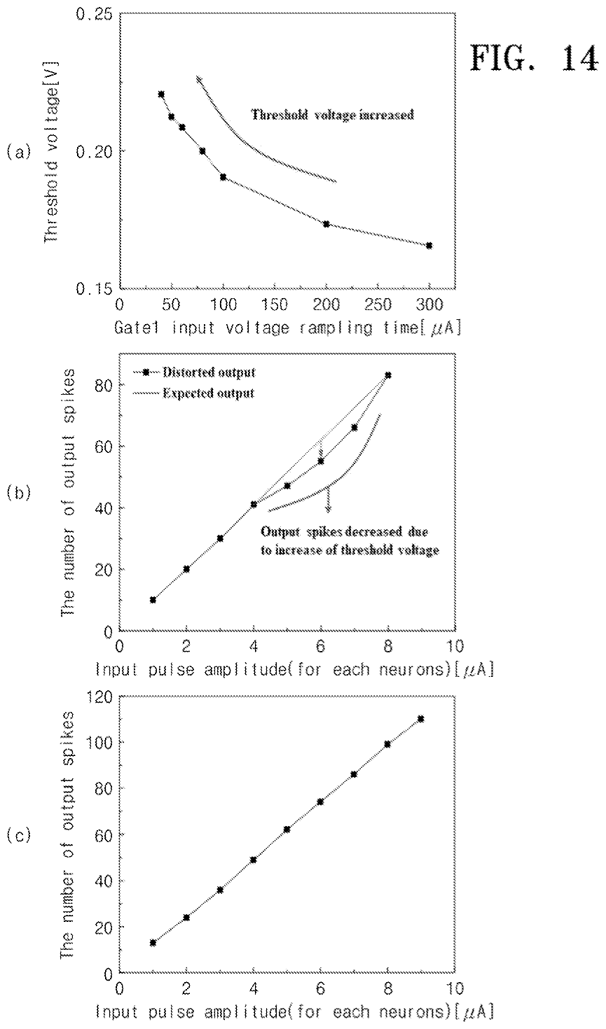

The threshold difference or variation among neurons can not only occur due to the device parameter variation in hardware implementation, but also occur due to the operation conditions (temperature, spike frequency, etc.) of each neuron. The present inventive concept can compensate the threshold variation among neurons due to operation conditions as shown in FIG. 14.

In order to see the inference accuracy of the present inventive concept under threshold variation due to device characteristics, the output characteristics of the SNNs including neuron of FIG. 8 were tested where the threshold variation due to operation conditions was intentionally made to the SNNs by varying threshold depending on the input speed increasement: (a) the threshold voltages of the neurons change differently depending on the difference in the speed of the input(speed of the membrane potential); (b) the membrane potentials increase differently depending on different constant input currents. Referring to FIG. 14b, a neuron having a high input current increases a membrane potential rapidly, thereby threshold voltage increases, so that the neuron generates spikes less than a normal value. In this case, if the neuron discharges the membrane potential by a constant amount after the spike generation in accordance with the present inventive concept, it can be confirmed that the threshold voltage difference among neurons are compensated, thereby showing linear outputs as shown in FIG. 14c.

The present inventive concept compensates for the threshold difference and/or variation among neurons that can occur in the spiking neural networks, so that the present inventive concept can be applied to any fields using a neuron having an integration and a firing function, and an artificial intelligence industry using the neural networks.

The present inventive concept can be also applied to the neuron of the SNNs configured by software and/or hardware, and a biomimetic sensor or an actuator using the spiking neurons.

While the present inventive concept has been described with what is presently considered to be exemplary embodiments, it is to be understood that the present inventive concept is not limited to the disclosed embodiments, but, on the contrary, is intended to cover various modifications and equivalent arrangements included within the spirit and scope of the appended claims. While the present inventive concept has been particularly shown and described with reference to preferred embodiments, it will be understood by those skilled in the art that various changes in form and details may be made therein without departing from the spirit and scope of the present inventive concept as defined by the appended claims.

What is claimed is:

1. A method for compensating a difference and/or a variation of a neuron threshold for a firing in a spiking neural network, the method comprising:
adjusting an effective threshold for a next firing after a firing of each neuron to be the same as a target threshold in each neuron.

2. The method of claim 1, wherein adjusting an effective threshold of each neuron comprises lowering a membrane potential of each neuron by an amount of the target threshold after the firing of each neuron.

3. The method of claim 1, wherein the target threshold is lower than a designed threshold of a neuron when a neural network is implemented in a hardware.

4. The method of claim 1, wherein an effective threshold for a second and subsequent firings is set all equal to the target threshold.

5. The method of claim 1, wherein the target threshold is adjusted to be less than a real threshold of each neuron.

6. A method for discharging a membrane potential after a firing of neuron in a spiking neural network, the method comprising discharging the same amount of a membrane potential for each neuron after the firing.

7. The method of claim 6, wherein each neuron fires to generate a spike when a membrane potential of a time integration and accumulation of an input signal exceeds a threshold.

8. A resetting method a neuron for a next firing after a firing of a neuron in a neural network, the resetting comprising reducing the amount of accumulated input signals by the same amount for each neuron.

9. The resetting of claim 8, wherein the accumulated input signals are obtained by time integration of the input signals, and
wherein the neuron fires to generate a spike when the accumulated input signals exceed a threshold.

10. A spiking neural network comprising a plurality of neurons,
wherein the plurality of neurons time-integrate and accumulate an input signal and fire an output spike when the accumulated input signal exceeds a threshold, and
wherein after firing the spike, the amount of accumulated input signals is reduced by the same amount of a target threshold for firing next spike.

11. The apparatus of claim 10, wherein each neuron comprises:
an accumulation unit accumulating an input signal by time-integrating;
a firing unit firing an output signal when the accumulated input signal of the accumulation unit exceeds a threshold; and
a threshold adjusting unit reducing the amount of the accumulated input signal of the accumulation unit by the amount of a target threshold in response to the output spike of the firing unit.

12. The apparatus of claim 10, wherein each neuron, after firing a first output spike, fires subsequent output spikes when accumulated input signals in the accumulation unit exceed the target threshold.
